(19) United States
(12) Patent Application Publication
(10) Pub. No.: US 2010/0183210 A1
(43) Pub. Date: Jul. 22, 2010

(54) COMPUTER-ASSISTED ANALYSIS OF COLONIC POLYPS BY MORPHOLOGY IN MEDICAL IMAGES

(76) Inventors: Robert L. Van Uitert, Hollis, NH (US); Senthil Periaswamy, Beavercreek, OH (US); Ryan McGinnis, London, OH (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 12/357,545

(22) Filed: Jan. 22, 2009

(51) Int. Cl. G06K 9/00

(52) U.S. Cl. 382/131

(57) ABSTRACT

The application discloses computer-based apparatus and methods for analysis of images of the colon to assist in the detection of colonic polyps. The apparatus and methods include the classification of anomalies which are suspected colonic polyps by morphological types, and the use of information about the morphological type to assist in the determination of whether the anomaly is a polyp.

### FIELD

The application discloses computer-based apparatus and methods for analysis of images of the colon to assist in the detection of colonic polyps.

### BACKGROUND

Colon cancer is the second leading cause of cancer death among men and women in the United States. The identification of suspicious polyps in the colonic lumen may be a critical first step in detecting the early signs of colon cancer. Many colon cancers can be prevented if precursor colonic polyps are detected and removed.

Computed tomographic (CT) and magnetic resonance (MR) colonography, two new “virtual” techniques for imaging the colonic lumen, have emerged as alternatives to the invasive optical colonoscopy procedure, which has traditionally been considered the gold standard for viewing the colon. CT imaging systems, for example, may acquire a series of cross-sectional images (i.e., slices) of the abdomen using scanners and x-rays. Computer software may be used to construct additional imagery from the slices. Physicians may inspect the imagery for indicators of colonic polyps.

There may be several difficulties associated with the inspection of such medical imagery. A physician may be required to review a large amount of image data, as the entire colon of a human is approximately 2 meters long. The physician may also be required to distinguish normal or healthy tissue or other features that may exhibit polyp-like characteristics from actual colonic polyps. Examples of such items may include residual stool, colonic folds, or the ileocecal valve. Such difficulties may lead the physician to longer interpretation times and the potential for incorrect detection and/or diagnosis due to human error, such as error resulting from fatigue.

Recently, physicians have used computer-assisted analysis to inspect virtual colonography medical imagery and identify potential colonic polyps. Also known as computer-aided detection or “CAD,” it has been demonstrated that physicians who use a CAD system as a “second set of eyes” may detect more cancers with fewer callbacks and unnecessary follow-up procedures than those who do not.

Many prior art CAD systems and methods have been described that detect polyps in the colon with extremely high sensitivity, usually on the order of 95-100%, depending on the sizes of the polyps studied. Unfortunately, an unacceptable number of normal tissue and feature detections (i.e., false positives) may also result in order to achieve this high sensitivity rate. To achieve acceptable clinical performance (e.g., a high sensitivity at a low false positive rate), CAD systems may need to accurately eliminate a significant number of false positives detected before presenting the results to a physician.

To determine if a detected anomaly of interest is a true polyp or is normal tissue or another normal feature, prior art CAD systems and methods may measure characteristics or “features” of the detected anomaly. Such features may include, for example, the size, the shape, the curvature, the density, and the contrast of the anomaly's pixels or voxels. The values of these features may then be analyzed by a classification algorithm or “classifier” that computes and outputs a decision as to whether the detected anomaly is of concern or “suspicious.” To compute such a decision, the classifier may analyze the feature values against learning or “training” obtained from previously-labeled samples of known polyps and known normal tissue. The computed decision may then be used to determine whether the detected anomaly should be presented to a physician for inspection, undergo further inspection by the CAD system, or be disregarded as normal tissue. Some prior art CAD systems and methods directed towards such steps include those discussed in: U.S. Pat. No. 6,345,112, U.S. Pat. No. 6,556,696, U.S. Pat. No. 7,260,250, U.S. Pat. No. 7,440,601, U.S. Pat. No. 7,379,572, U.S. Pat. No. 7,043,064, U.S. Pat. No. 7,272,251, U.S. Pat. No. 7,346,209, and U.S. Pat. No. 7,386,165; U.S. Published Patent Application 20080015419, and U.S. Published Patent Application 20080194946; “Computer-assisted detection of colonic polyps with CT colonography using neural networks and binary classification trees,” Medical Physics, Volume 30, Issue 1, pp. 52-60 (January 2003), “Multiple Neural Network Classification Scheme for Detection of Colonic Polyps in CT Colonography Data Sets,” Academic Radiology, Volume 10, Issue 2, Pages 154-160, and “Support vector machines committee classification method for computer-aided polyp detection in CT colonography,” Academic Radiology, Volume 12, Issue 4, Pages 479-486, all by Jerebko et al.

The prior art CAD systems and methods referenced above may be characterized in that they improve the degree of class separability between polyps and normal tissue by relying upon features and/or classification techniques that discriminate polyps from normal tissue (or vice versa). However, a major factor impacting the degree of class separability may be the wide range of “morphologies” or “types” of polyps in the colon, examples of which are shown in FIG. 1. Types range from pedunculated polyps that are attached to a stalk protruding from the colon wall, to flat polyps that may have a “plateau” and are typically attached directly adjacent to the colon wall. Each type of polyp may not only exhibit different characteristics from normal tissue, but also from other types of polyps. The fact that there are different types of polyp may be a limiting factor on the ability to distinguish between polyps and normal tissue, if as in many prior art systems all detected anomalies are analyzed by the same formulae. Indeed, studies suggest that detection of polyps may be improved by first determining the type of polyp that a particular anomaly may be, and then analyzing whether or not the anomaly is a polyp using methods designed or tuned for that type of polyp alone. For example, prior art CAD systems and methods that utilize curvature features to distinguish polyps from normal tissue may frequently misclassify flat polyps as normal tissue because flat polyps have significantly different distributions of curvature feature values than sessile and pedunculated polyps. (See, for example, “Computed Tomographic Virtual Colonoscopy Computer-Aided Polyp Detection in a Screening Population,” Gastroenterology, Volume 129, Issue 6, Pages 1832-1844). Ideally, the curvature features of flat polyps should be studied independently from the curvature features of sessile or pedunculated polyps.

Thus, prior art CAD systems may not determine if a given detected anomaly is a polyp or is normal tissue with a combination of acceptable sensitivity and a low false positive rate. This may be attributed to, at least in partial part, the widely varying and often conflicting ranges of feature characteristic values that are exhibited by different types of polyps, which have a negative effect on the class separability of polyps from normal tissue.

Furthermore, prior art approaches to polyp detection may lack an accurate way of presenting to a physician whether an anomaly is characterized as being of a particular “morphology” or “type” as shown in FIG. 1. This may be attributed to the fact that prior art CAD systems and methods have been traditionally designed and utilized to simply determine whether an anomaly of interest is suspicious enough to be output as a polyp. The characterization of the anomaly was left to the physician. However, CAD systems and methods that automatically determine the morphology of a polyp may satisfy a long felt but unsolved need of the physician in terms of workflow improvement. For example, insight may be provided to the physician as to how a particular anomaly of interest was evaluated by the CAD system, which may then be used by the physician in his or her subsequent manual evaluation.

It is therefore an object of this disclosure to overcome both the aforementioned and other limitations associated with prior art approaches to the analysis of anomalies of interest in colonography medical imagery.

### SUMMARY

Disclosed are computer-implemented methods of presenting suspected colonic polyps in a colon under study to a user.

The methods comprise: receiving, through at least one input device, digital imagery representing at least a portion of a colon; obtaining information identifying at least one candidate polyp anomaly in said at least a portion of a colon; assigning, in at least one processor, each said candidate polyp anomaly to at least one of a plurality of polyp morphological classes; for each said candidate polyp anomaly, determining, in at least one processor, based upon the assignment of said candidate polyp anomaly to at least one of a plurality of polyp morphological classes, a measure of suspiciousness; and outputting, through at least one output device, information identifying at least one candidate polyp anomaly whose measure of suspiciousness exceeds a predetermined threshold.

Receiving, through at least one input device, digital imagery representing at least a portion of a colon, may comprise receiving said imagery by means of a network connection. At least a portion of the digital imagery representing at least a portion of a colon may derive from a non-invasive imaging method. The non-invasive imaging method may be selected from the set composed of CT scanning and MRI imaging.

Obtaining information identifying at least one candidate polyp anomaly in said at least a portion of a colon may comprise using at least some of said digital imagery to identify, in at least one processor, at least one candidate polyp anomaly. Identifying may comprise selecting pixels or voxels representing said at least one candidate polyp anomaly in said digital imagery representing at least a portion of the colon. Obtaining information identifying at least one candidate polyp anomaly in said at least a portion of a colon may comprise receiving from a user, through at least one input device, said information identifying at least one candidate polyp anomaly.

Assigning may further comprise: computing a feature vector on said candidate polyp anomaly; and assigning said candidate polyp anomaly to at least one of a plurality of polyp morphological classes based on said feature vector computed. At least one feature value of which the feature vector is comprised may be computed based on pixels or voxels representing a neck of said candidate polyp anomaly, and at least one feature value of which the feature vector is comprised may be computed based on pixels or voxels representing a head of said candidate polyp anomaly. The pixels or voxels representing the neck of said candidate polyp anomaly may be segmented. Assigning may further comprise: computing a discriminant score from said feature vector; comparing said discriminant score to at least one threshold; and responsive to a determination that said discriminant score exceeds or does not exceed each said threshold, assigning said candidate polyp anomaly to at least one polyp morphological class. Assigning may further comprise: responsive to a determination that said candidate polyp anomaly belongs to a predetermined morphological class, computing a second discriminant score from said feature vector; comparing said second discriminant score to at least one threshold; and responsive to a determination that said second discriminant score exceeds or does not exceed each said threshold, assigning said candidate polyp anomaly to at least one polyp morphological class. The polyp morphological classes to which a candidate polyp anomaly may be assigned may comprise at least one class chosen from the group containing pedunculated, non-pedunculated, sessile, non-sessile, flat and non-flat.

Determining the measure of suspiciousness may comprise, based upon the polyp morphological class to which the candidate colonic anomaly has been assigned, obtaining a feature vector of said candidate polyp anomaly; based upon the polyp morphological class to which the candidate colonic anomaly has been assigned, obtaining a set of stored classification parameters; and calculating the measure of suspiciousness using said feature vector and said set of stored classification parameters.

Outputting, through at least one output device, information identifying at least one candidate polyp anomaly may comprise outputting digital imagery representing said at least one candidate polyp anomaly. Said outputting may further comprise: displaying at least a portion of said digital imagery representing at least a portion of the colon on at least one output device; and specially depicting said at least one candidate polyp anomaly whose measure of suspiciousness exceeds a predetermined threshold in said portion displayed. In said special depiction of said at least one candidate polyp anomaly, the polyp morphological class to which the said candidate polyp anomaly belongs may be indicated.

Also disclosed is a computer-readable medium having computer-readable instructions stored thereon which, as a result of being executed in a computer system having at least one processor, at least one output device and at least one input device, instruct the computer system to perform the above methods.

Also disclosed is a computer system for detecting suspected colonic polyps, comprising at least one processor, at least one input device and at least one output device, so configured that the computer system is operable to perform the above methods.

### FIGURES

FIG. 1 illustrates various types of polyps that may appear in a colon.

FIG. 2 is a block diagram of an illustrative system for acquiring and processing colonography medical imagery.

FIG. 3 is an overview showing computer-assisted analysis method steps that may be performed on colonography medical imagery in accordance with certain embodiments of the systems and methods disclosed herein.

FIG. 4 illustrates an example of the operational steps that may be performed to compute a morphological class assignment for an anomaly of interest according to certain embodiments of the systems and methods disclosed herein.

FIG. 5 illustrates an example of the operational steps that may be performed to assign a morphological class to an anomaly of interest according to certain embodiments of the systems and methods disclosed herein.

FIG. 6 illustrates an example of the operational steps that may be performed by to train a classifier from samples of polyps having different morphologies according to certain embodiments of the systems and methods disclosed herein.

FIG. 7 illustrates an example of the steps that may be performed to measure the suspiciousness of an anomaly of interest according to certain embodiments of the systems and methods disclosed herein.

FIG. 8 illustrates an example of the operational steps that may be performed to establish suitable weights and predetermined thresholds of a classifier according to certain embodiments of the systems and methods disclosed herein.

### DETAILED DESCRIPTION OF EMBODIMENTS

In the following detailed description of embodiments, reference is made to the accompanying drawings that form a part hereof, and in which are shown, by way of illustration and not by way of limitation, specific embodiments in which the methods and systems disclosed herein may be practiced. It is to be understood that other embodiments may be utilized and that logical, mechanical, and electrical changes may be made without departing from the scope of the methods and systems disclosed herein.

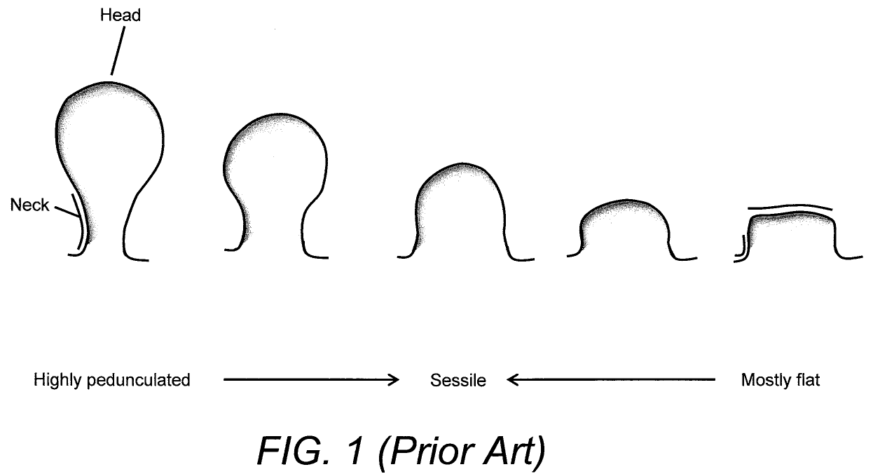

FIG. 1, previously discussed, illustrates various types of polyps that may appear in a colon. These illustrations are by way of example, and other classifications of polyps may be utilized in conjunction with embodiments of the systems and methods disclosed herein

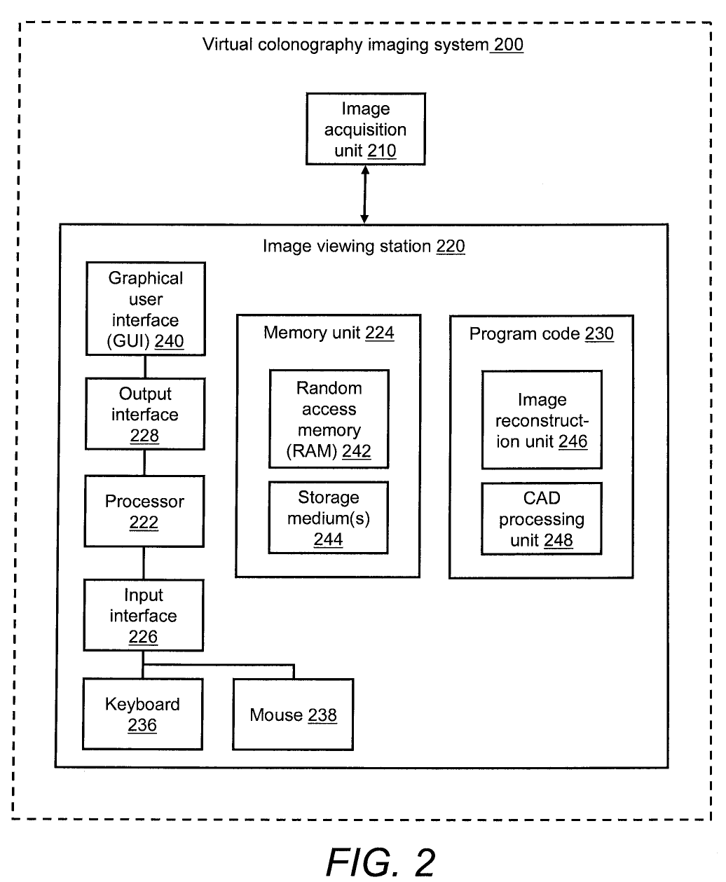

FIG. 2 is a block diagram of an illustrative system 200 for acquiring and processing colonography medical imagery. More specifically, system 200 may be suitable for processing a digital representation of the colon in accordance with the computer-assisted analysis methods disclosed herein. The system described is for reference purposes only. Other systems may be used in carrying out embodiments of the methods disclosed herein.

Virtual colonography imaging system 200 includes an image acquisition unit 210 for performing a medical imaging procedure of a patient's colon and an image viewing station 220 for processing and displaying the imagery to a physician or other user of the system. Image acquisition unit 210 may connect to and communicate with image viewing station 220 via any type of communication interface, including but not limited to physical interfaces, network interfaces, software interfaces, and the like. The communication may be by means of a physical connection, or may be wireless, optical or of any other means. It will be understood by a person of skill in the art that image acquisition unit 210 and image viewing station 220 may be deployed as parts of a single system or, alternatively, as parts of multiple, independent systems, and that any such deployment may be utilized in conjunction with embodiments of the methods disclosed herein. If image acquisition unit 210 is connected to image viewing station 220 by means of a network or other direct computer connection, the network interface or other connection means may be the input device for image viewing station 220 to receive imagery for processing by the methods and systems disclosed herein. Alternatively, image viewing station 220 may receive images for processing indirectly from image acquisition unit 210, as by means of transportable storage devices (not shown in FIG. 2) such as but not limited to CDs, DVDs or flash drives, in which case readers for said transportable storage devices may function as input devices for image viewing station 220 for processing images according to the methods disclosed herein.

Image acquisition unit 210 is representative of a system that can acquire imagery of a patient's abdominal region using non-invasive imaging procedures (e.g., a virtual colonography imaging procedure). Such a system may use computed tomography (CT), magnetic resonance imaging (MRI), or another suitable method for creating images of a patient's abdominal and colonic regions as will be known to a person of skill in the art. Examples of vendors that provide CT and MRI scanners include the General Electric Company of Waukesha, Wis. (GE); Siemens AG of Erlangen, Germany (Siemens); and Koninklijke Philips Electronics of Amsterdam, Netherlands.

Image viewing station 220 is representative of a system that can analyze the medical imagery for anomalies and output both the medical imagery and the results of its analysis. Image viewing station 220 may further comprise a processor unit 222, a memory unit 224, an input interface 226, an output interface 228, and program code 230 containing instructions that can be read and executed by the station. Input interface 226 may connect processor unit 222 to an input device such as a keyboard 236, a mouse 238, and/or another suitable device as will be known to a person of skill in the art, including for example and not by way of limitation a voice-activated system. Thus, input interface 226 may allow a user to communicate commands to the processor, one such exemplary command being the initiation of the computer-assisted analysis methods disclosed herein. Output interface 228 may further be connected to processor unit 222 and an output device such as a graphical user interface (GUI) 240. Thus, output interface 228 may allow image viewing station 220 to transmit data from the processor to the output device, one such exemplary transmission including a graphical representation of an anatomical colon and anomalies classified as polyps for display to a user on GUI 240.

Memory unit 224 may include conventional semiconductor random access memory (RAM) 242 or other forms of memory known in the art; and one or more computer readable-storage mediums 244, such as a hard drive, floppy drive, read/write CD-ROM, tape drive, flash drive, optical drive, etc. Stored in program code 230 may be an image reconstruction unit 246 for constructing additional imagery from the images acquired by image acquisition unit 210; and a CAD processing unit 248 for automatically identifying and analyzing anomalies in accordance with the methods disclosed herein.

It is further noted that while image reconstruction unit 246 and CAD processing unit 248 are depicted as being components within image viewing station 220, one skilled in the art will appreciate that such components may be deployed as parts of separate computers, computer processors, or computer systems. For example, image reconstruction unit 246 may be deployed as part of a virtual colonography review workstation system (e.g., V3D-Colon™ from Viatronix, Inc. of Stony Brook, N.Y.).

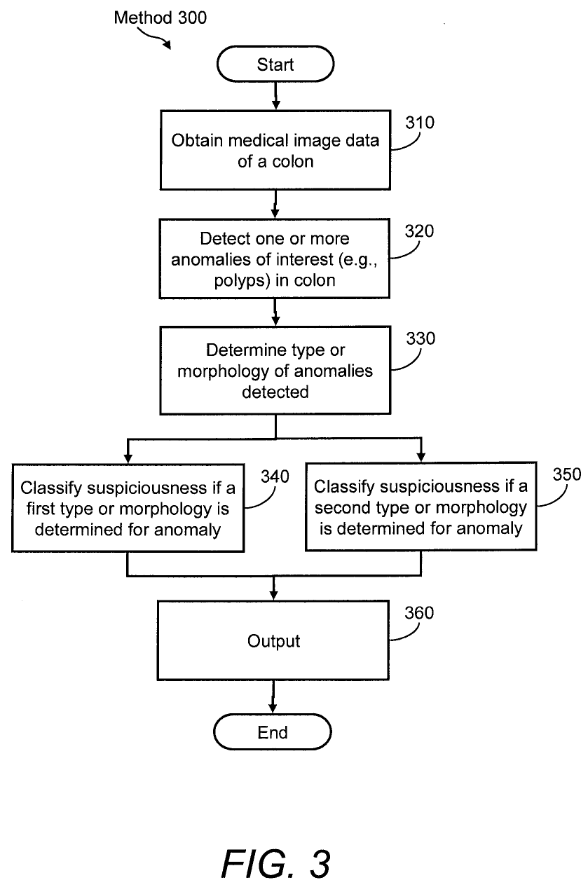

FIG. 3 is an overview showing computer-assisted analysis method steps that may be performed on colonography medical imagery in accordance with certain embodiments of the systems and methods disclosed herein. The overall steps performed in the method will first be introduced. At step 310, medical image data representing a colon, or at least a portion of a colon, is received in memory. At step 320, the image units (e.g., the voxels or the pixels) representing anomalies of interest, such as polyp candidates in the colon, are identified. At step 330, an initial classification step is performed to determine the type or morphology of polyp that each anomaly identified most closely models or represents. At step 340, in response to a determination at step 330 that the anomaly belongs to a first morphological class, a first subsequent classification step is performed to classify the anomaly as a member of that class with a measure of suspiciousness. Alternatively, at step 350, in response to a determination at step 330 that the anomaly belongs to a second morphological class, a second subsequent classification step is instead performed to classify the anomaly as a member of that class with a measure of suspiciousness. Steps 330-350 may then be repeated so that all anomalies of interest identified at step 320 may be classified as belonging to a particular morphological class with a measure of suspiciousness. (While FIG. 3 and this description illustrate the processing flow based upon a potential classification of polyps into two types or classes, a “first” and a “second,” this is a simplification for purposes of clarity of discussion only, and in fact any number of types or classes may be used.) At step 360, the anomalies classified with measures of suspiciousness above a preset threshold are output in ways that assist a physician or other user with colon inspection and disease diagnosis. In certain embodiments, the anomalies may be specially rendered and graphically displayed along with at least a portion of the colon. Having briefly introduced the overall steps performed in FIG. 3, we will now describe each step in greater detail.

The medical image data representing a colon, or at least a portion of a colon, may be received at step 310 in a memory such as memory unit 224. In certain embodiments, the medical image data may be a plurality of cross-sectional, two-dimensional (2-D) images of a patient's abdomen. Such imagery may be generated by performing an abdominal scan procedure on a patient using image acquisition unit 210 or other suitable imaging system. In certain other embodiments, the medical image data may be a three-dimensional (3-D) volumetric image or “volume” of the patient's abdomen. A suitable volumetric image may be constructed from the acquired cross-sectional images using computer software. For example, cross-sectional images generated using image acquisition unit 210 may be transferred to image viewing station 220, whereby image reconstruction unit 246 may construct a 3-D volume of the abdominal region by performing a filtered backprojection algorithm on the cross-sectional images as is known in the art. The volumetric image may be comprised of a series of slices. By way of a non-limiting example, each slice image in the volume may be constructed at 512×512 pixels and a spatial resolution of 0.75 millimeters×0.75 millimeters, and the medical image volume may be comprised of a total of 300-600 slices with a spatial resolution of 1 millimeter.

The colon may then be analyzed at step 320 to identify anomalies, such as polyps, that may be of interest. In certain embodiments, anomalies of interest may be identified using automated techniques which are further described hereinbelow. All imagery received may be automatically processed for anomalies. This may include the processing of regions outside of the colon as means to identify “extracolonic findings” in virtual colonography imagery. For example, regions representing a lung of a patient, which are often imaged as part of colonography imaging procedures, may be processed as a means to identify potential nodules. However, in certain other embodiments, only the pixels or voxels representing the colon wall (i.e., surface or perimeter) may be processed for anomalies. Many computer-implemented techniques for automatically identifying and/or segmenting a representation of an anatomical colon are known in the art, any of which may be suitable for restricting anomalies of interest identified to only the colon wall. One suitable technique or “colon segmentation algorithm” can be seen in U.S. Pat. No. 6,246,784, “Method for segmenting medical images and detecting surface anomalies in anatomical structures,” which is incorporated herein by reference. In this patent, a region growing technique is described for identifying and segmenting the air, fluid, and wall of a colon. However, other techniques described in the art may also be performed to identify the voxels or pixels representing the colon wall.

Many computer-implemented techniques for automatically identifying representations of polyp candidates or other anomalies that may be of interest are also known in the art, any of which may be suitable for performing at step 320. Techniques for identifying polyps may compute measures of curvature, shape index, sphericity, and/or other geometric features to identify clusters of pixels or voxels that have the general characteristics of polyps. One suitable technique or “polyp detection algorithm” can be seen in U.S. Pat. No. 7,236,620, “Computer-aided detection methods in volumetric imagery,” which is incorporated herein by reference. In this patent, polyp candidates are identified within an image mask representing the segmented colon using spherical summation techniques. However, other techniques may be performed to identify the voxels or pixels representing anomalies of interest, and other measures besides curvature, shape index and sphericity may be employed.

The colon segmentation and polyp detection algorithms described hereinabove may be performed either serially or in parallel with one another. For example, in a serial example, the colon may be first identified from the rest of the received imagery, and only imagery representing the colon or a subset of the colon (e.g., a luminal surface model or “mesh” of the colon, which may be implemented as fully described in previously referenced U.S. Pat. No. 6,246,784) may be processed to identify anomalies. Alternatively, all imagery received may be processed for anomalies and an output of a colon segmentation step, such as an image mask representing the patient's colon, may be applied to restrict the candidate anomalies under further consideration to only those appearing inside the colon.

A segmentation step may further be performed on the voxels or pixels of each anomaly identified, as is known in the art. Two examples of suitable segmentation algorithms that may be performed are active contours or deformable surfaces. The algorithm for performing the segmentation step may also be constructed so as to identify and segment the pixels or voxels representing the neck (i.e., the stalk) of each anomaly, as polyp detection algorithms do not traditionally identify this region. As illustrated in FIG. 1, the neck attaches the polyp-like portion or “head” of an anomaly to the wall of the colonic lumen. Features calculated on the segmented neck may be used to classify the anomaly, as will be further described hereinbelow. An example of how one segmentation algorithm, a deformable surface model, can be used to segment the necks of polyps can be seen in “3D colonic polyp segmentation using dynamic deformable surfaces,” Yao et al., Medical Imaging 2004: Proceedings of the SPIE, Volume 5369, pp. 280-289 (2004). Alternatively, features other than the “neck” may be identified, segmented and used to classify the anomaly.

In certain embodiments, a physician may wish to perform the classification methods disclosed herein on candidate anomalies of interest identified manually by the physician. In such embodiments, the medical imagery may be manually inspected by a physician. For example, a representation of at least a portion of the colon may be displayed on GUI 240 to a physician or other user of image viewing station 220. Using input devices such as keyboard 236 and mouse 238, the physician may select the pixels or voxels of specific anomalies of interest in the medical imagery. The automated segmentation of such anomalies as described hereinabove may then be performed to segment a more accurate representation of the physician's manual selection. This may also include the neck of each anomaly, which may not be manually specified by the physician. Pixel or voxel data representing such anomaly objects may then be used as input to the subsequent, automated classification steps described hereinbelow. In further embodiments, the specific anomalies of interest on which to perform the classification methods described herein may be derived from a combination of manual and automatic polyp anomaly identification methods. For example, at least one anomaly may first be identified manually by a physician using image viewing station 220, some number of additional anomalies may be then identified automatically by image viewing station 220, and anomalies identified by either or both methods may then be input to the classification procedure described herein.

Prior to classifying anomalies of interest identified at step 320, it is well understood in the art that various anomalies identified may be rejected as normal tissue or other normal features (i.e., false positives) in a “pre-screening” step. This is typically achieved by performing relatively computationally non-intensive techniques before the more computationally intensive classification is performed on remaining anomalies of interest. By way of a non-limiting example, one particularly useful technique may be to compute the value of a curvature measurement (e.g., an elliptical curvature measurement) on each anomaly identified and reject those anomalies with a curvature value below a preset threshold as normal tissue. By way of another non-limiting example, another particularly useful technique may be to perform a stool classification algorithm on each anomaly identified and reject those anomalies classified with high sensitivity as stool. One example of a suitable, automated method for distinguishing stool from detected polyp anomaly candidates is fully described in pending U.S. patent application Ser. No. 12/179,787, “Computer-aided detection and display of colonic residue in medical imagery of the colon,” incorporated herein by reference. Any such “pre-screening” steps optionally may be performed to arrive at a list of anomalies of interest on which classification step 330 may then be performed.

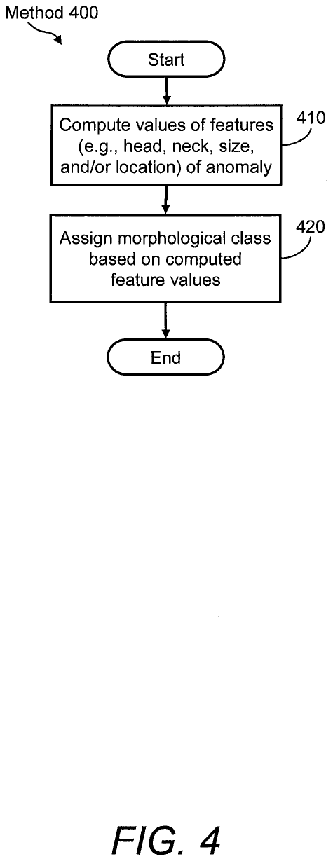

FIG. 4 illustrates the steps that may be performed to determine the type or morphology of the polyp that a detected anomaly most closely models or represents, as is done in step 330. The overall steps performed in the method will first be introduced. At step 410, the values of one or more features are computed for the candidate polyp anomaly. In certain embodiments, the features may be computed so as to characterize the head and the neck of the anomaly. At step 420, a classification algorithm or “classifier” is performed on the feature vector to assign the candidate polyp anomaly to at least one of a plurality of morphological classes. The classifier may be modeled to output morphological class decisions based on the different types of polyps shown in FIG. 1, such as but not limited to pedunculated polyps, sessile polyps, and flat polyps. Having briefly introduced the overall steps performed in FIG. 4, we will now describe each step in full detail.

The morphology of an anomaly may be modeled in feature vector space by computing features on different portions of the anomaly of interest at step 410. As shown in FIG. 1, for example, pedunculated polyps exhibit characteristics of a well-defined neck or stalk protruding from the colon wall to the “head” of the polyp. In contrast, sessile and flat polyps have little neck and are typically attached directly adjacent to the colon wall. As also shown in FIG. 1, flat polyps exhibit characteristics of a “plateau” in which the “head” of the polyp has an area of well-defined flatness (i.e., very low curvature) and multiple areas that are curved. In contrast, sessile and pedunculated polyps are mostly curved with little to no flatness. Thus, in certain embodiments, the morphology of an anomaly may be modeled in feature vector space by computing separate feature values on the regions representing the neck and head of an anomaly of interest. Exemplary features that may be useful for characterizing the neck of the anomaly include the height, the width, and/or the curvature of the neck. Exemplary features that may be useful for characterizing the head of the anomaly include the curvature, the aspect ratio, the shape index, the sphericity, the converging gradients, and/or the Fourier margin descriptors of the head. However, it should be understood that the choice of features that may be used, and the choice of regions that may be used, is not limited to those specifically enumerated herein.

The morphology of an anomaly may be modeled in feature vector space by computing other features non-specific to a particular region, such as but not limited to the total size (e.g., area) and/or location of the anomaly in the colonic lumen (e.g., distance from the rectum). For example, research indicates that anomalies exhibiting larger sizes may be more likely pedunculated while anomalies exhibiting smaller sizes may be more likely sessile. (See, for example, “Computed Tomographic Virtual Colonoscopy Computer-Aided Polyp Detection in a Screening Population,” Gastroenterology, Volume 129, Issue 6, Pages 1832-1844.) Research further indicates that location features may distinguish anomalies of a particular morphology, as certain types of polyps may appear more frequently in certain locations of the colonic lumen. (See, for example, “A prospective clinicopathological and endoscopic evaluation of flat and depressed colorectal lesions in the United Kingdom,” The American Journal of Gastroenterology, Volume 98, Issue 11, Pages 2543-2549.) The addition of such features may be further useful in modeling the morphology of an anomaly in a feature vector space above and beyond those features specific to the head, neck or other region of the anomaly.

The aforementioned features are merely intended to be examples that have utility in modeling the morphology of an anomaly. The exact feature vector to compute may comprise other features not necessarily presented by way of example. It should also be recognized that the exact feature vector to compute may be formed empirically (i.e., using expert knowledge) or, alternatively, formed using the assistance of a computer-implemented feature selection process. As is known in the art, in a feature selection process, an optimal vector of features is determined experimentally using the assistance of a computer system and a feature selection algorithm. Examples of feature selection algorithms that may be used to perform such a step include but are not limited to greedy selection, greedy elimination, exhaustive, best first, or other approaches well known in the art of pattern recognition.

The values of these features are then input to a classification algorithm or “classifier” at step 420. The classifier outputs morphological class decisions based on the feature values inputted and prior learning, such as but not limited to prior learning obtained from training. Many classification algorithms or combination of classification algorithms (e.g., committees) are known in the art, any of which may be suitable for performing such a classification step. These include, but are not limited to, linear classifiers, quadratic classifiers, neural networks, decision-trees, fuzzy logic classifiers, support vector machines (SVM), Bayesian classifiers, and/or k-nearest neighbor classifiers.

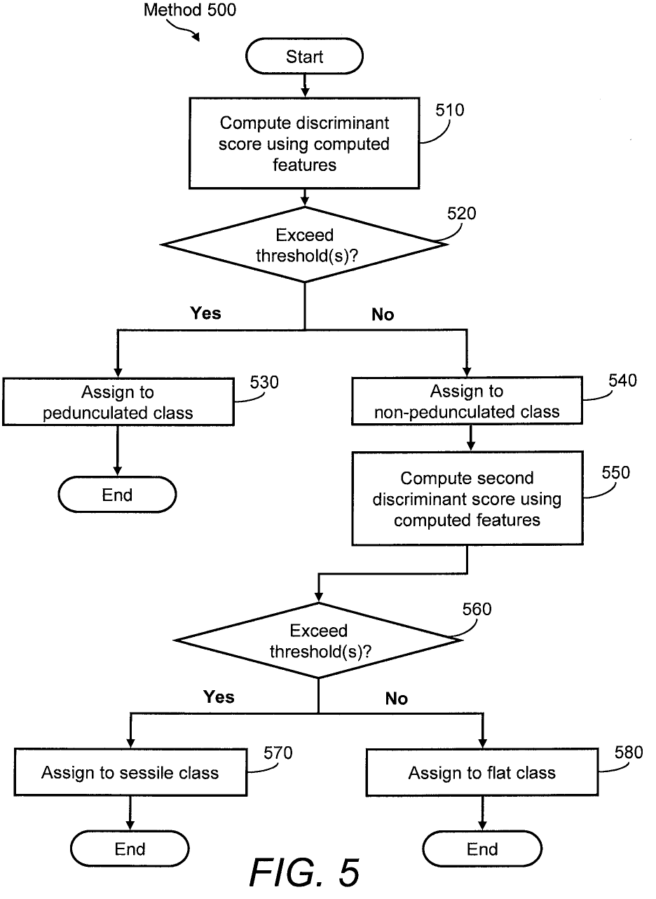

The specific operational steps of the classification algorithm performed at step 420 may be highly dependent on the particular combination of features in the vector and the particular combination of morphological classes that may be determined by the algorithm. By way of a non-limiting example, FIG. 5 illustrates one example of the operational steps that may be performed at step 420 to compute at least one morphological class for an anomaly of interest, using a classification system based upon classification of polyps into pedunculated and non-pedunculated types, and the further classification of non-pedunculated polyps into sessile and flat types. It is to be understood that the methods described herein may be applied to other sets of classifications in addition or alternatively to those used for illustrative purposes in FIG. 5.

At step 510, a discriminant score is computed for quantitatively characterizing the “pedunculation” of the anomaly (i.e., whether the anomaly has or grows on a peduncule). A suitable discriminant score may be computed using a combination of feature values computed for the anomaly at step 410. For example, the discriminant score may be computed by multiplying the neck height, the neck width, the neck curvature, the size, and the location of the anomaly by weighting factors or “weights” and summing the weighted feature values together. Of course, additional features beyond those enumerated herein may be utilized, and not all of those enumerated must be used.

At step 520, the discriminant score computed is compared against a predetermined threshold parameter, which acts as a decision boundary in the assignment of a class. For example, an anomaly may be classified as “pedunculated” at step 530 if the anomaly's discriminant score exceeds the predetermined threshold for that class, while the anomaly may be classified as “non-pedunculated” at step 540 if the score is below the threshold. Alternatively, the threshold parameter can be used to compute a score indicating a probability or a likelihood that the anomaly belongs to a pedunculated and/or non-pedunculated morphological class. For example, the score may be a measure describing the distance in feature vector space between the discriminant score and threshold parameter.

In certain embodiments, if the anomaly is classified as “non-pedunculated”, additional classification steps may be performed to further classify the morphology of the anomaly. For example, and not by way of limitation, at step 550, a second discriminant score may be computed for quantitatively characterizing the “flatness” of the anomaly. A suitable discriminant score may be computed using a combination of feature values computed for the anomaly at step 410, which may include certain features also used to quantitatively characterize the pedunculation of the anomaly. For example, a second discriminant score may be computed by multiplying the neck curvature, the size, the location, the head curvature, the head aspect ratio, the head shape index, the head sphericity, the head converging gradients, and the head Fourier descriptors of the anomaly by predetermined weighting factors or “weights” and summing the weighted values together. Of course, additional features beyond those enumerated herein may be utilized, and not all of those enumerated must be used.

At step 560, the second discriminant score computed is compared against a second predetermined threshold parameter, which acts as a decision boundary in the assignment of a class. For example, an anomaly may be classified as “sessile” at step 570 if the anomaly's second discriminant score exceeds the second predetermined threshold, while the anomaly may be classified as “flat” at step 580 if the second discriminant score is below the second threshold. Alternatively, the second threshold parameter can be used to compute a score indicating a probability or a likelihood that the anomaly belongs to a sessile and/or flat morphological class. For example, the score may be a measure describing the distance in feature vector space between the second discriminant score and second threshold parameter.

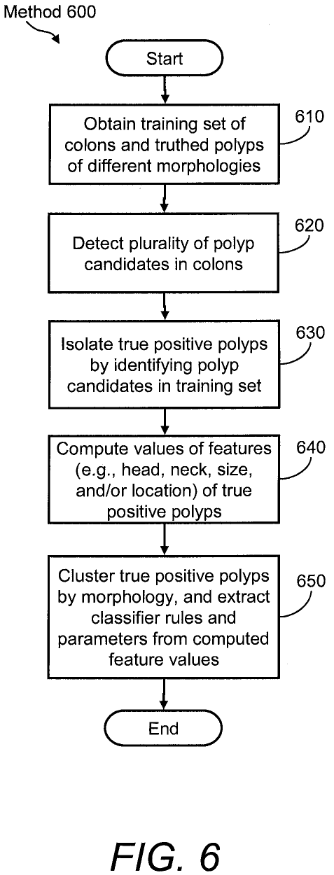

Suitable weights and predetermined thresholds of a classifier may be established in accordance with a training process. The steps of one example of such a training procedure are illustrated in FIG. 6 and will now be fully described. Again, a classification system based upon classification of polyps into pedunculated and non-pedunculated types, and the further classification of non-pedunculated polyps into sessile and flat types, is employed in the illustration. It is to be understood that the methods described herein may be applied to other sets of classifications in addition or alternatively.

At step 610, a training set of medical images representing various colons, or at least portions of various colons, are received. Further received is data relating to samples of polyp anomalies that have been identified in the colons received (i.e., “truthed”) by a physician or other suitable expert, as well as the morphology or type of each polyp identified. For example, the data may be an electronic file detailing the image coordinates of each polyp anomaly sample and whether each polyp anomaly is a pedunculated polyp, a sessile polyp, or a flat polyp.

At step 620, without using any truth information as input, the image units representing polyp anomaly candidates are automatically detected in the colons of the training set. For example, the colon segmentation and polyp detection algorithms may be executed on the training set using a computer system such as system 200. The results of both algorithms may be combined to automatically identify polyp anomaly candidates as described at step 320. The automated segmentation step described hereinabove may further be performed to achieve a better segmented representation of each polyp anomaly as also described at step 320.

The polyp anomaly candidates detected at step 620 are compared against the truthed polyp anomalies received at step 610. Those polyp anomalies detected by both the computer system and human physician are isolated at step 630 as true positive polyp samples for further analysis. It should be recognized that polyp detection algorithms such as those described herein identify many different types of polyps, such as pedunculated polyps, sessile polyps, and flat polyps. Thus, the true positive polyp samples isolated for further analysis will contain samples of each type of polyp.

At step 640, the same feature vector described with reference to step 410 is computed on each true positive polyp sample. For example, the values of features relating to the neck, the head, the size, and/or the location of each true positive polyp sample may be computed. Of course, additional features beyond those enumerated herein may be utilized, and not all of those enumerated must be used.

At step 650, the true positive polyps are clustered according to the morphology truth markings received. For example, given samples of pedunculated polyps, sessile polyps, and flat polyps, true positive pedunculated polyps and true positive non-pedunculated polyps may be clustered. The computed feature values of these clusters are then used to develop various classification rules and parameters that describe conditions when an anomaly should be classified as pedunculated or non-pedunculated. In certain embodiments, the classification parameters developed may be one or more weighting factors that describe the conditional probabilities of one or more features given a class. For example, a weighting factor describing the conditional probability of a neck height feature value given the neck height feature values of pedunculated and non-pedunculated polyps may be established. Such weighting factors may be computed using a conditional probability density function such as a linear discriminant analysis (LDA), a discriminative model such as a support vector machine (SVM), or other suitable technique for determining the optimal parameters of a classifier from samples having known classes. The parameters may also be one or more thresholds that describe the conditional probabilities of a discriminant score given a class. For example, a threshold describing the conditional probability of a discriminant score given the discriminant scores of pedunculated and non-pedunculated polyps may be established. Such thresholds may be computed, for example, using a receiver operating characteristic (ROC) curve and selected based on acceptable sensitivity and false positive rates.

Returning to FIG. 3, in response to the classification of a detected anomaly as belonging to a particular morphological class at step 330, one of a plurality of additional classifiers may then be invoked to measure the suspiciousness of the anomaly, given the morphology determined. For example, in embodiments where the anomaly may be assigned to a pedunculated class at step 330, a pedunculated classifier may be invoked at step 340 to measure the suspiciousness of the anomaly. In embodiments where the anomaly may be assigned to a non-pedunculated class at step 330, a non-pedunculated classifier may be invoked at step 350 to measure the suspiciousness of the anomaly.

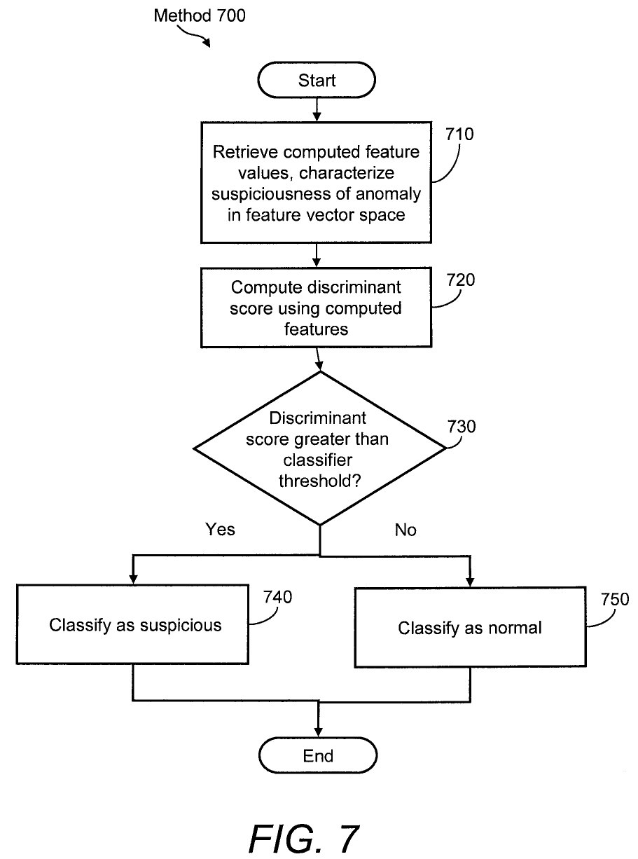

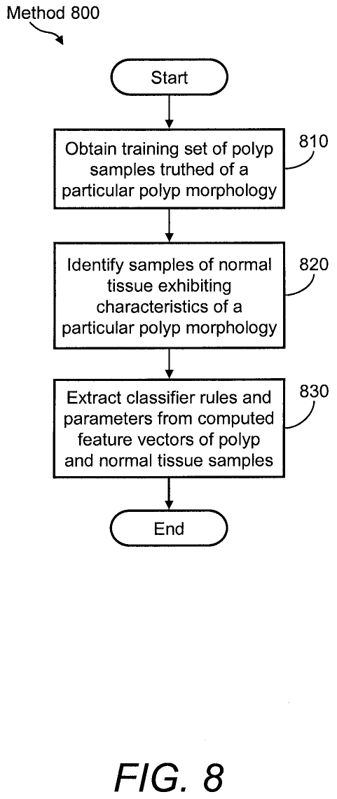

FIG. 7 illustrates an example of the operational steps that may be performed by both a pedunculated classifier at step 340 and a non-pedunculated classifier at step 350 to measure the suspiciousness of an anomaly of interest. The exemplary steps described in FIG. 7 may be performed by a classification algorithm or combination of classification algorithms (e.g., committees) such as, but not limited to, linear classifiers, quadratic classifiers, neural networks, decision-trees, fuzzy logic classifiers, support vector machines (SVM), Bayesian classifiers, and/or k-nearest neighbor classifiers. In certain embodiments, the pedunculated classifier performed at step 340 and non-pedunculated classifier performed at step 350 may use the same classification algorithm (e.g., a linear classifier). However, in other embodiments, the pedunculated classifier and non-pedunculated classifier may use different classification algorithms, the choices of which may be empirically decided by performing any number of such algorithms on samples of polyps and samples of normal tissue having a specific morphology in a training process, which will be further described with reference to FIG. 8. Again, it is to be understood that the classification of polyps into pedunculated and non-pedunculated is used by way of illustration, and that other classifications may be used with the methods and systems described herein.

At step 710, the feature vector computed on the candidate polyp anomaly at step 410 is retrieved from a memory such as memory unit 224 and used to characterize the suspiciousness of the anomaly as a point in n-dimensional feature vector space. A suitable feature vector space may be formed using any combination of the features previously computed at step 410. For example, and not by way of limitation, measures of curvature of the head of an anomaly have utility in distinguishing most types of polyps from normal tissue. The feature vector space may also be formed by computing additional feature values such as intensity or texture, for example. Additionally, the feature vector space may be formed using features specific to the morphology of the anomaly to represent the anomaly in a morphological-specific feature vector space. By way of a non-limiting example, features measuring the diameter and/or hyperbolic curvature of the neck of the anomaly may be used as part of the feature vector space for representing pedunculated anomalies, as such features may be of particular use in distinguishing pedunculated polyps from folds exhibiting pedunculated characteristics. By way of another non-limiting example, features measuring the brightness and/or texture (e.g., Fourier descriptors) of the anomaly may be used as part of the feature vector space for representing flat anomalies, as such features may be of particular use in distinguishing flat polyps from tagged stool exhibiting flat characteristics. The head of flat polyps have a tendency to acquire tagging agents and thus, are more often mistaken for tagged stool. (See, for example, “Flat polyps of the Colon: Detection with 16-MDCT Colonography—Preliminary Results,” The American Journal of Roentgenology, 2006 June; 186(6): 1611-1617.)

At step 720, a discriminant score is computed for quantitatively characterizing the suspiciousness of the anomaly. A suitable discriminant score may be computed by multiplying each feature value by predetermined weighting parameters and summing the weighted values together, for example. The specific weighting parameters to use for computing the discriminant score may be determined by modeling or “training” based on polyps and normal tissue having the same morphology for which the classification process is to be performed. Thus, a different set of weighting parameters may be retrieved from a memory such as memory unit 224 depending upon the morphology of the anomaly. This allows each classifier invoked in accordance with a particular morphology to weight the importance of each feature in the feature vector differently, so as to optimize the overall suspiciousness calculation for each anomaly.

At step 730, the discriminant score computed for the anomaly may be compared against a predetermined threshold parameter, which acts as a decision boundary to decide whether an anomaly should be labeled as “suspicious” at step 730 or “normal” at step 740. Alternatively, the threshold parameter can be used to compute a probability or score indicating a measure of suspiciousness for the anomaly. For example, the probability or score may be a measure describing the distance between the discriminant score and threshold parameter. The specific predetermined threshold parameter to use as the decision boundary also may be determined by modeling or “training” based on polyps and normal tissue having the same morphology for which the classification process is to be performed. Thus, a different predetermined threshold parameter may be retrieved from a memory such as memory unit 224 in depending upon the morphology of the anomaly. This allows each classifier invoked in accordance with a particular morphology to characterize a discriminant score differently, so as to optimize the overall suspiciousness calculation for each anomaly.

Suitable weights and predetermined thresholds of a pedunculated classifier and non-pedunculated classifier may be established in accordance with a training process. The steps of one example of one such training procedure are illustrated in FIG. 8 and will now be fully described. Again, it is to be understood that the classification of polyps into pedunculated and non-pedunculated is used by way of illustration, and that other classifications may be used with the methods and systems described herein.

The training set of medical images received and used in the training procedure described in FIG. 5 are also suitable for the training procedure in FIG. 8. In fact, it may be advantageous to use such a training set as the true positive polyp samples are already identified in this training set. However, FIG. 8 will be discussed as if the training procedure is being performed on a new training set of medical images.

At step 810, a training set of medical images representing various colons, or at least portions of various colons, are received. Further received is data relating to samples of pedunculated polyp anomalies that have been identified in the colons received (i.e., “truthed”) by a physician or other suitable expert. For example, the data may be an electronic file detailing the image coordinates of each pedunculated polyp anomaly sample in the colon.

At step 820, samples of normal tissue anomalies exhibiting characteristics of pedunculated polyps are identified in the training set. While such a step may be performed manually by a physician, the following computer implemented approach may be performed instead. First, polyp anomaly candidates may be automatically detected in the colons of the training set. For example, as previously described, the colon segmentation and polyp detection algorithms may be executed on the training set as a means to detect pluralities of different types of polyp anomaly candidates, including pedunculated polyp anomaly candidates. Next, the same feature vector described with reference to step 410 may be computed on each polyp anomaly candidate detected. For example, the values of features relating to the neck, the head, the size, and/or the location of each polyp anomaly candidate may be computed. Of course, additional regions and features beyond those enumerated herein may be utilized, and not all of those enumerated must be used. Next, the morphological or type classification rules and parameters developed in the training process of FIG. 5 may be applied to the feature vector computed. Those polyp anomaly candidates that are classified as “pedunculated” by the morphological classifier but that are not identified by the human physician as pedunculated polyps are isolated for further analysis.

At step 830, the truthed pedunculated polyps received at step 810 and samples of normal tissue anomalies exhibiting characteristics of pedunculated polyps isolated at step 820 are then clustered. The computed feature values of these clusters are then used to develop various classification rules and parameters that describe conditions when an anomaly should be classified as a pedunculated true positive or a pedunculated false positive (i.e., pedunculated normal tissue). For example, the parameters may be one or more weighting factors that describe the conditional probabilities of one or more features given a pedunculated-specific class. Such weighting factors may be computed using a conditional probability density function such as a linear discriminant analysis (LDA), a discriminative model such as a support vector machine (SVM), or other suitable technique for determining the optimal parameters of a classifier from pedunculated-specific samples of polyps and normal tissue. The parameters may also be one or more thresholds that describe the conditional probabilities of a weighted and summed vector of features given a pedunculated-specific class. Such thresholds may be computed, for example, using a receiver operating characteristic (ROC) curve and selected based on acceptable sensitivity and false positive rates for pedunculated polyps.

Although the training process described in FIG. 8 illustrates how to train a classifier from samples of pedunculated polyps and samples of pedunculated normal tissue, a similar process may be performed to train a classifier from samples of polyps and samples of normal tissue of other morphologies, such as non-pedunculated, sessile and/or flat anomalies. This allows the development of a plurality of classifiers that may be invoked to measure the suspiciousness of the anomaly depending upon the morphology determined.

Returning to FIG. 3, having classified each identified anomaly of interest in the colon with a measure of suspiciousness, information associated with the anomalies may be output at step 360 in various ways that assist a physician in reviewing the colon and diagnosing the patient.

It is well-known in the art of computer-aided detection that information associated with only those anomalies having measures of suspiciousness above a predetermined system threshold (e.g., the operating point of the system) are typically output to a physician. In certain embodiments, those anomalies with suspiciousness measures that exceed the predetermined system threshold may be specially depicted from the imagery of the colon, or at least a portion of the colon, on a graphical user interface such as GUI 240. For example, the pixels or voxels representing each suspicious anomaly may be depicted with a special color to draw the attention of the physician to these anomalies. Other information computed during the computer-assisted analysis process described hereinabove may also be outputted. For example, a classifier probability or score of suspiciousness associated with each anomaly, such as the probability describing the distance between the anomaly discriminant score and threshold parameter described hereinabove, may be outputted on or near each anomaly. Alternatively or additionally, a classifier probability or score of morphology or type associated with each anomaly, such as the probability describing the distance between the anomaly discriminant score and threshold parameter described hereinabove, may be outputted on or near each anomaly. Anomalies classified as normal may require no further action in terms of presentation and display to a physician.

In further embodiments, those anomalies with suspiciousness measures that exceed the predetermined system threshold may be further specially depicted in accordance with the specific morphology determined for each anomaly at step 330. For example, anomalies classified as “suspicious” and of a pedunculated morphology may be specially depicted from anomalies classified as “suspicious” and of a non-pedunculated morphology. Such a depiction may be presented in the form of different geometric marks (e.g., shapes), colors, labels, intensities or other visual indicators around and/or directly on the pixels or voxels of each anomaly on the output device. By presenting such a depiction, the physician's attention may be drawn to evaluate specific characteristics of an anomaly based on morphology. For example, the physician may be drawn to evaluate the neck of an anomaly classified and specially depicted as a pedunculated anomaly to confirm the computer-assisted assessment that the anomaly is indeed a polyp. The presentation of such a depiction may further assist the physician in making a diagnosis. For example, flat polyps may have a higher likelihood of being malignant or cancerous than sessile or pedunculated polyps, and may thus require different follow-up action. (See, for example, “A prospective clinicopathological and endoscopic evaluation of flat and depressed colorectal lesions in the United Kingdom,” The American Journal of Gastroenterology, Volume 98, Issue 11, Pages 2543-2549). Alternatively, a report describing the anomalies identified, including the particular morphology of each anomaly, may be output using data generated from the computer-assisted analysis methods disclosed hereinabove. For example, the generation of a report in a Digital Imaging and Communications in Medicine (DICOM) format is well-known in the art and may be suitable for presenting outputting such data.

Polyp anomalies may be classified in accordance with the system and methods disclosed hereinabove, but it is possible in a given case that no polyp anomalies may exceed a predetermined system threshold, and thus that no information associated with such polyp anomalies may be outputted. This may suggest to a physician that the patient's colonic region may be normal, healthy, or without indicators of cancer. Thus, in certain embodiments, only the imagery of the colon, or at least a portion of the colon, may be displayed in response to the performance of the methods disclosed herein. Alternatively, a message may further be displayed indicating that no suspicious anomalies were identified. In these embodiments, the absence of anomalies after performing the methods disclosed herein is as substantially important to the physician as the presence of anomalies.

It is noted that terms like “preferably,” “commonly,” and “typically” are not utilized herein to limit the scope of the disclosure or to imply that certain features are critical, essential, or even important to the structure or function of the methods and systems disclosed herein. Rather, these terms are merely intended to highlight alternative or additional features that may or may not be utilized in a particular embodiment.

Having described the methods and systems in detail and by reference to specific embodiments thereof, it will be apparent that modifications and variations are possible without departing from the scope of the disclosure. More specifically, although some aspects of the disclosed methods and systems may be identified herein as preferred or particularly advantageous, it is contemplated that the present disclosure is not limited to these preferred aspects.

1. A computer-implemented method of presenting suspected colonic polyps in a colon under study to a user comprising:
a) receiving, through at least one input device, digital imagery representing at least a portion of a colon;
b) obtaining information identifying at least one candidate polyp anomaly in said at least a portion of a colon;
c) assigning, in at least one processor, each said candidate polyp anomaly to at least one of a plurality of polyp morphological classes;
d) for each said candidate polyp anomaly, determining, in at least one processor, based upon the assignment of said candidate polyp anomaly to at least one of a plurality of polyp morphological classes, a measure of suspiciousness; and
e) outputting, through at least one output device, information identifying at least one candidate polyp anomaly whose measure of suspiciousness exceeds a predetermined threshold.

2. The method of claim 1, wherein receiving, through at least one input device, digital imagery representing at least a portion of a colon comprises receiving said imagery by means of a network connection.

3. The method of claim 1, wherein at least a portion of the digital imagery representing at least a portion of a colon derives from a non-invasive imaging method.

4. The method of claim 3, wherein the non-invasive imaging method is selected from the set composed of CT scanning and MRI imaging.

5. The method of claim 1, wherein obtaining information identifying at least one candidate polyp anomaly in said at least a portion of a colon comprises using at least some of said digital imagery to identify, in at least one processor, at least one candidate polyp anomaly.

6. The method of claim 5, wherein identifying comprises selecting pixels or voxels representing said at least one candidate polyp anomaly in said digital imagery representing at least a portion of the colon.

7. The method of claim 1, wherein obtaining information identifying at least one candidate polyp anomaly in said at least a portion of a colon comprises receiving from a user, through at least one input device, said information identifying at least one candidate polyp anomaly.

8. The method of claim 1, wherein assigning further comprises:
c1. computing a feature vector on said candidate polyp anomaly; and
c2. assigning said candidate polyp anomaly to at least one of a plurality of polyp morphological classes based on said feature vector computed.

9. The method of claim 8, wherein at least one feature value of which the feature vector is comprised is computed based on pixels or voxels representing a neck of said candidate polyp anomaly, and at least one feature value of which the feature vector is comprised is computed based on pixels or voxels representing a head of said candidate polyp anomaly.

10. The method of claim 9, further comprising segmenting the pixels or voxels representing the neck of said candidate polyp anomaly.

11. The method of claim 8 wherein said assigning further comprises:
c3. computing a discriminant score from said feature vector;
c4. comparing said discriminant score to at least one threshold; and
c5. responsive to a determination that said discriminant score exceeds or does not exceed each said threshold, assigning said candidate polyp anomaly to at least one polyp morphological class.

12. The method of claim 11 wherein said assigning further comprises:
c6. responsive to a determination that said candidate polyp anomaly belongs to a predetermined morphological class, computing a second discriminant score from said feature vector;
c7. comparing said second discriminant score to at least one threshold; and
c8. responsive to a determination that said second discriminant score exceeds or does not exceed each said threshold, assigning said candidate polyp anomaly to at least one polyp morphological class.

13. The method of claim 1, wherein the polyp morphological classes to which a candidate polyp anomaly may be assigned comprise at least one class chosen from the group containing pedunculated, non-pedunculated, sessile, non-sessile, flat and non-flat.

14. The method of claim 1, wherein determining the measure of suspiciousness comprises:
d1. based upon the polyp morphological class to which the candidate colonic anomaly has been assigned, obtaining a feature vector of said candidate polyp anomaly;
d2. based upon the polyp morphological class to which the candidate colonic anomaly has been assigned, obtaining a set of stored classification parameters; and
d3. calculating the measure of suspiciousness using said feature vector and said set of stored classification parameters.

15. The method of claim 1, wherein outputting, through at least one output device, information identifying at least one candidate polyp anomaly comprises outputting digital imagery representing said at least one candidate polyp anomaly.

16. The method of claim 15, wherein said outputting further comprises:
e1. displaying at least a portion of said digital imagery representing at least a portion of the colon on at least one output device; and
e2. specially depicting said at least one candidate polyp anomaly whose measure of suspiciousness exceeds a predetermined threshold in said portion displayed.

17. The method of claim 16 further comprising: in said special depiction of said at least one candidate polyp anomaly, indicating the polyp morphological class to which the said candidate polyp anomaly belongs.

18. A computer-readable medium having computer-readable instructions stored thereon which, as a result of being executed in a computer system having at least one processor, at least one output device and at least one input device, instruct the computer system to perform a method, comprising:
a) receiving, through at least one input device, digital imagery representing at least a portion of a colon;
b) obtaining information identifying at least one candidate polyp anomaly in said at least a portion of a colon;
c) assigning, in at least one processor, each said candidate polyp anomaly to at least one of a plurality of polyp morphological classes;
d) for each said candidate polyp anomaly, determining, in at least one processor, based upon the assignment of said candidate polyp anomaly to at least one of a plurality of polyp morphological classes, a measure of suspiciousness; and
e) outputting, through at least one output device, information identifying at least one candidate polyp anomaly whose measure of suspiciousness exceeds a predetermined threshold.

19. The computer-readable medium of claim 18, wherein receiving, through at least one input device, digital imagery representing at least a portion of a colon comprises receiving said imagery by means of a network connection.

20. The computer-readable medium of claim 18, wherein at least a portion of the digital imagery representing at least a portion of a colon derives from a non-invasive imaging method.

21. The computer-readable medium of claim 20, wherein the non-invasive imaging method is selected from the set composed of CT scanning and MRI imaging.

22. The computer-readable medium of claim 18, wherein obtaining information identifying at least one candidate polyp anomaly in said at least a portion of a colon comprises using at least some of said digital imagery to identify, in at least one processor, at least one candidate polyp anomaly.

23. The computer-readable medium of claim 22, wherein identifying comprises selecting pixels or voxels representing said at least one candidate polyp anomaly in said digital imagery representing at least a portion of the colon.

24. The computer-readable medium of claim 18, wherein obtaining information identifying at least one candidate polyp anomaly in said at least a portion of a colon comprises receiving from a user, through at least one input device, said information identifying at least one candidate polyp anomaly.

25. The computer-readable medium of claim 18, wherein assigning further comprises:
c1. computing a feature vector on said candidate polyp anomaly; and
c2. assigning said candidate polyp anomaly to at least one of a plurality of polyp morphological classes based on said feature vector computed.

26. The computer-readable medium of claim 25, wherein at least one feature value of which the feature vector is comprised is computed based on pixels or voxels representing a neck of said candidate polyp anomaly, and at least one feature value of which the feature vector is comprised is computed based on pixels or voxels representing a head of said candidate polyp anomaly.

27. The computer-readable medium of claim 26, further comprising segmenting the pixels or voxels representing the neck of said candidate polyp anomaly.

28. The computer-readable medium of claim 25 wherein said assigning further comprises:
c3. computing a discriminant score from said feature vector;
c4. comparing said discriminant score to at least one threshold; and
c5. responsive to a determination that said discriminant score exceeds or does not exceed each said threshold, assigning said candidate polyp anomaly to at least one polyp morphological class.

29. The computer-readable medium of claim 28 wherein said assigning further comprises:
c6. responsive to a determination that said candidate polyp anomaly belongs to a predetermined morphological class, computing a second discriminant score from said feature vector;
c7. comparing said second discriminant score to at least one threshold; and
c8. responsive to a determination that said second discriminant score exceeds or does not exceed each said threshold, assigning said candidate polyp anomaly to at least one polyp morphological class.

30. The computer-readable medium of claim 18, wherein the polyp morphological classes to which a candidate polyp anomaly may be assigned comprise at least one class chosen from the group containing pedunculated, non-pedunculated, sessile, non-sessile, flat and non-flat.

31. The computer-readable medium of claim 18, wherein determining the measure of suspiciousness comprises:
d1. based upon the polyp morphological class to which the candidate colonic anomaly has been assigned, obtaining a feature vector of said candidate polyp anomaly;
d2. based upon the polyp morphological class to which the candidate colonic anomaly has been assigned, obtaining a set of stored classification parameters; and
d3. calculating the measure of suspiciousness using said feature vector and said set of stored classification parameters.

32. The computer-readable medium of claim 18, wherein outputting, through at least one output device, information identifying at least one candidate polyp anomaly comprises outputting digital imagery representing said at least one candidate polyp anomaly.

33. The computer-readable medium of claim 32, wherein said outputting further comprises:
e1. displaying at least a portion of said digital imagery representing at least a portion of the colon on at least one output device; and
e2. specially depicting said at least one candidate polyp anomaly whose measure of suspiciousness exceeds a predetermined threshold in said portion displayed.

34. The computer-readable medium of claim 33 further comprising: in said special depiction of said at least one candidate polyp anomaly, indicating the polyp morphological class to which the said candidate polyp anomaly belongs.

35. A computer system for detecting suspected colonic polyps, comprising at least one processor, at least one input device and at least one output device, so configured that the computer system is operable to:
a) receive, through at least one input device, digital imagery representing at least a portion of a colon;
b) obtain information identifying at least one candidate polyp anomaly in said at least a portion of a colon;
c) assign, in at least one processor, each said candidate polyp anomaly to at least one of a plurality of polyp morphological classes;
d) for each said candidate polyp anomaly, determine, in at least one processor, based upon the assignment of said candidate polyp anomaly to at least one of a plurality of polyp morphological classes, a measure of suspiciousness; and
e) output, through at least one output device, information identifying at least one candidate polyp anomaly whose measure of suspiciousness exceeds a predetermined threshold.

36. The system of claim 35, wherein receiving, through at least one input device, digital imagery representing at least a portion of a colon comprises receiving said imagery by means of a network connection.

37. The system of claim 35, wherein at least a portion of the digital imagery representing at least a portion of a colon derives from a non-invasive imaging method.

38. The system of claim 37, wherein the non-invasive imaging method is selected from the set composed of CT scanning and MRI imaging.

39. The system of claim 35, wherein obtaining information identifying at least one candidate polyp anomaly in said at least a portion of a colon comprises using at least some of said digital imagery to identify, in at least one processor, at least one candidate polyp anomaly.

40. The system of claim 39, wherein identifying comprises selecting pixels or voxels representing said at least one candidate polyp anomaly in said digital imagery representing at least a portion of the colon.

41. The system of claim 35, wherein obtaining information identifying at least one candidate polyp anomaly in said at least a portion of a colon comprises receiving from a user, through at least one input device, said information identifying at least one candidate polyp anomaly.

42. The system of claim 35, wherein assigning further comprises:
c1. computing a feature vector on said candidate polyp anomaly; and
c2. assigning said candidate polyp anomaly to at least one of a plurality of polyp morphological classes based on said feature vector computed.

43. The system of claim 42, wherein at least one feature value of which the feature vector is comprised is computed based on pixels or voxels representing a neck of said candidate polyp anomaly, and at least one feature value of which the feature vector is comprised is computed based on pixels or voxels representing a head of said candidate polyp anomaly.

44. The system of claim 43, further comprising segmenting the pixels or voxels representing the neck of said candidate polyp anomaly.

45. The system of claim 42 wherein said assigning further comprises:
c3. computing a discriminant score from said feature vector;
c4. comparing said discriminant score to at least one threshold; and
c5. responsive to a determination that said discriminant score exceeds or does not exceed each said threshold, assigning said candidate polyp anomaly to at least one polyp morphological class.

46. The system of claim 45 wherein said assigning further comprises:
c6. responsive to a determination that said candidate polyp anomaly belongs to a predetermined morphological class, computing a second discriminant score from said feature vector;
c7. comparing said second discriminant score to at least one threshold; and
c8. responsive to a determination that said second discriminant score exceeds or does not exceed each said threshold, assigning said candidate polyp anomaly to at least one polyp morphological class.

47. The system of claim 35, wherein the polyp morphological classes to which a candidate polyp anomaly may be assigned comprise at least one class chosen from the group containing pedunculated, non-pedunculated, sessile, non-sessile, flat and non-flat.

48. The system of claim 35, wherein determining the measure of suspiciousness comprises:
d1. based upon the polyp morphological class to which the candidate colonic anomaly has been assigned, obtaining a feature vector of said candidate polyp anomaly;
d2. based upon the polyp morphological class to which the candidate colonic anomaly has been assigned, obtaining a set of stored classification parameters; and
d3. calculating the measure of suspiciousness using said feature vector and said set of stored classification parameters.

49. The system of claim 35, wherein outputting, through at least one output device, information identifying at least one candidate polyp anomaly comprises outputting digital imagery representing said at least one candidate polyp anomaly.

50. The system of claim 49, wherein said outputting further comprises:
e1. displaying at least a portion of said digital imagery representing at least a portion of the colon on at least one output device; and
e2. specially depicting said at least one candidate polyp anomaly whose measure of suspiciousness exceeds a predetermined threshold in said portion displayed.

51. The system of claim 50 further comprising: in said special depiction of said at least one candidate polyp anomaly, indicating the polyp morphological class to which the said candidate polyp anomaly belongs.
